(19) United States
(12) Patent Application Publication
(10) Pub. No.: US 2026/0167449 A1
(43) Pub. Date: Jun. 18, 2026

(54) POST-PROCESSING APPARATUS, IMAGE FORMING APPARATUS, AND IMAGE FORMING SYSTEM

(71) Applicants: Shota Yoshida, Kanagawa (JP); Tomomichi Hoshino, Kanagawa (JP); Yuusuke Shibasaki, Tokyo (JP); Wataru Takahashi, Tokyo (JP); Sho Asano, Kanagawa (JP); Atsushi Shinoda, Kanagawa (JP); Kotomi Kameyama, Kanagawa (JP); Shuuto Tohkaishi, Kanagawa (JP); Hirotaka Yasukawa, Kanagawa (JP); Shingo Yoshizawa, Kanagawa (JP); Naofumi Yoshida, Kanagawa (JP); Ryota Takayama, Kanagawa (JP); Akira Kunieda, Tokyo (JP); Jun Yamada, Kanagawa (JP); Yuji Suzuki, Kanagawa (JP); Wataru Nozaki, Kanagawa (JP); Satoshi Hirata, Saitama (JP); Takuya Okamoto, Tokyo (JP)

(72) Inventors: Shota Yoshida, Kanagawa (JP); Tomomichi Hoshino, Kanagawa (JP); Yuusuke Shibasaki, Tokyo (JP); Wataru Takahashi, Tokyo (JP); Sho Asano, Kanagawa (JP); Atsushi Shinoda, Kanagawa (JP); Kotomi Kameyama, Kanagawa (JP); Shuuto Tohkaishi, Kanagawa (JP); Hirotaka Yasukawa, Kanagawa (JP); Shingo Yoshizawa, Kanagawa (JP); Naofumi Yoshida, Kanagawa (JP); Ryota Takayama, Kanagawa (JP); Akira Kunieda, Tokyo (JP); Jun Yamada, Kanagawa (JP); Yuji Suzuki, Kanagawa (JP); Wataru Nozaki, Kanagawa (JP); Satoshi Hirata, Saitama (JP); Takuya Okamoto, Tokyo (JP)

(73) Assignee: ETRIA Co., Ltd., Kanagawa (JP)

(21) Appl. No.: 19/332,665

(22) Filed: Sep. 18, 2025

(30) Foreign Application Priority Data
Dec. 12, 2024 (JP) 2024-217446

(51) Int. Cl. B65H 35/00; G03G 15/00

(52) U.S. Cl. CPC B65H 35/0006; G03G 15/6582; B65H 2553/00; B65H 2557/24; B65H 2801/27; G03G 2215/00599; G03G 2215/00738; G03G 2215/00818

(57) ABSTRACT

A post-processing apparatus includes a hole puncher and circuitry. The hole puncher includes a punching member, a motor to drive the punching member to perform a punching process as a post-processing on a sheet, and a sensor to measure a number of rotations of the motor to measure an actual punching time of the punching process on the sheet. The circuitry is to acquire the actual punching time, and sheet processing information and sheet information of the sheet; generate a trained model through machine learning using the sheet processing information and the actual punching time as training data; input the sheet processing information to the trained model to estimate an estimated punching time; calculate a time difference between the actual punching time and the estimated punching time; and compare the time difference and a threshold value to determine deterioration of a part member of the hole puncher.

### CROSS-REFERENCE TO RELATED APPLICATION

This patent application is based on and claims priority pursuant to 35 U.S.C. § 119 (a) to Japanese Patent Application No. 2024-217446, filed on Dec. 12, 2024, in the Japan Patent Office, the entire disclosure of which is hereby incorporated by reference herein.

### BACKGROUND

### Technical Field

Embodiments of the present disclosure relate to a post-processing apparatus, an image forming apparatus, and an image forming system.

### Related Art

Typical apparatuses include a typical technique for notifying a user of a time for maintenance of a unit included in a post-processing apparatus. An image forming apparatus in the art includes a technique of measuring a punching time taken from a start to an end of hole punching of paper by a hole punching unit, and making a maintenance request based on a result of comparing the actual punching time with a punching time predicted in advance for each thickness of the paper.

The technique disclosed in the image forming apparatus in the art is likely to inaccurately predict the punching time with a combination of a paper type and paper thickness that is not assumed in advance. For this reason, for example, more accurate prediction of a deterioration state is difficult due to wear of, for example, a hole punching pin.

### SUMMARY

Embodiments of the present disclosure described herein provide a novel post-processing apparatus including a hole puncher and circuitry. The hole puncher includes a punching member, a motor, and a sensor. The punching member includes a part member. The motor drives the punching member to perform a punching process as a post-processing on a sheet. The sensor measures a number of rotations of the motor to measure an actual punching time of the punching process on the sheet. The circuitry is to acquire the actual punching time, and sheet processing information including a process content of the post-processing performed on the sheet before an ejection of the sheet from the post-processing apparatus, and sheet information of the sheet; generate a trained model through machine learning using the sheet processing information and the actual punching time as training data; input the sheet processing information to the trained model to estimate an estimated punching time; calculate a time difference between the actual punching time and the estimated punching time; and compare the time difference and a threshold value to determine deterioration of the part member of the hole puncher.

Further, embodiments of the present disclosure described herein provide an image forming apparatus including a post-processing apparatus to perform a post-processing on a sheet. The post-processing apparatus performs a post-processing on a sheet, and includes a hole puncher and circuitry. The hole puncher includes a punching member, a motor, and a sensor. The punching member includes a part member. The motor drives the punching member to perform a punching process as a post-processing on a sheet. The sensor measures a number of rotations of the motor to measure an actual punching time of the punching process on the sheet. The circuitry is to acquire the actual punching time and sheet processing information including a process content of the post-processing performed on the sheet before an ejection of the sheet from the post-processing apparatus, and sheet information of the sheet; generate a trained model through machine learning using the sheet processing information and the actual punching time as training data; input the sheet processing information to the trained model to estimate an estimated punching time; calculate a time difference between the actual punching time and the estimated punching time; and compare the time difference and a threshold value to determine deterioration of the part member of the hole puncher.

Further, embodiments of the present disclosure described herein provide an image forming system including an image forming apparatus, a processing apparatus, and a post-processing apparatus. The image forming apparatus form an image on a sheet. The processing apparatus is coupled to the image forming apparatus via a network. The post-processing apparatus performs a post-processing on the sheet conveyed from the image forming apparatus. The post-processing apparatus includes a hole puncher and circuitry. The hole puncher includes a punching member, a motor, a sensor. The punching member includes a part member. The motor drives the punching member to perform a punching process as a post-processing on a sheet. The sensor measures a number of rotations of the motor to measure an actual punching time of the punching process on the sheet. The circuitry is to acquire the actual punching time, and sheet processing information including a process content of the post-processing performed on the sheet before an ejection of the sheet from the post-processing apparatus, and sheet information of the sheet; generate a trained model through machine learning using the sheet processing information and the actual punching time as training data; input the sheet processing information to the trained model to estimate an estimated punching time; calculate a time difference between the actual punching time and the estimated punching time; and compare the time difference and a threshold value to determine deterioration of the part member of the hole puncher.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view illustrating a configuration of an image forming system according to a first embodiment of the present disclosure;

FIG. 2 is a block diagram illustrating a configuration of the image forming system according to the first embodiment of the present disclosure;

FIG. 3 is a diagram illustrating a hardware configuration of a controller included in the post-processing apparatus according to the first embodiment of the present disclosure and an apparatus controller included in the image forming apparatus;

FIG. 4 is a plan view of the post-processing apparatus according to the first embodiment of the present disclosure;

FIG. 5 is a view illustrating a configuration of a punching mechanism in the post-processing apparatus according to the first embodiment of the present disclosure;

FIG. 6 is a view illustrating the configuration of the punching mechanism in the post-processing apparatus according to the first embodiment of the present disclosure;

FIG. 7 is a view illustrating the configuration of the punching mechanism in the post-processing apparatus according to the first embodiment of the present disclosure;

FIGS. 8A and 8B are graphs illustrating examples of waveforms detected by an encoder sensor of the post-processing apparatus according to the first embodiment of the present disclosure;

FIG. 9 is a block diagram illustrating a functional configuration of the post-processing apparatus 1 according to the first embodiment of the present disclosure;

FIG. 10 is a block diagram illustrating a functional configuration of a learning apparatus that generates a trained model according to the first embodiment of the present disclosure;

FIGS. 11A to 11C are diagrams for explaining a relationship among the image forming apparatus, the post-processing apparatus, and the trained model according to the first embodiment of the present disclosure;

FIG. 12 including FIGS. 12A and 12B is a table illustrating an example of a database obtained by combining sheet processing information and actual punching times according to the first embodiment of the present disclosure;

FIG. 13 is a flowchart of the flow of a process executed by the controller of the post-processing apparatus according to the first embodiment of the present disclosure;

FIG. 14 is a flowchart of the flow of a process executed by the controller of the post-processing apparatus according to a modification of the first embodiment of the present disclosure;

FIG. 15 is a flowchart of the flow of a process executed by the controller of the post-processing apparatus according to a modification of the first embodiment of the present disclosure;

FIG. 16 is a flowchart of the flow of a process executed by the controller of the post-processing apparatus according to a modification of the first embodiment of the present disclosure;

FIG. 17 is a flowchart of the flow of a process executed by the controller of the post-processing apparatus according to a modification of the first embodiment of the present disclosure;

FIG. 18 is a flowchart of the flow of a process executed by the controller of the post-processing apparatus according to a modification of the first embodiment of the present disclosure;

FIG. 19 is a flowchart of the flow of a process executed by the controller of the post-processing apparatus according to a modification of the first embodiment of the present disclosure;

FIG. 20 is a flowchart of the flow of a process executed by the controller of the post-processing apparatus according to a modification of the first embodiment of the present disclosure;

FIG. 21 is a block diagram illustrating a functional configuration of a post-processing apparatus according to a second embodiment of the present disclosure; and

FIG. 22 is a flowchart of the flow of a process executed by the controller of the post-processing apparatus according to the second embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

### First Embodiment

### Overall Configuration of Image Forming System

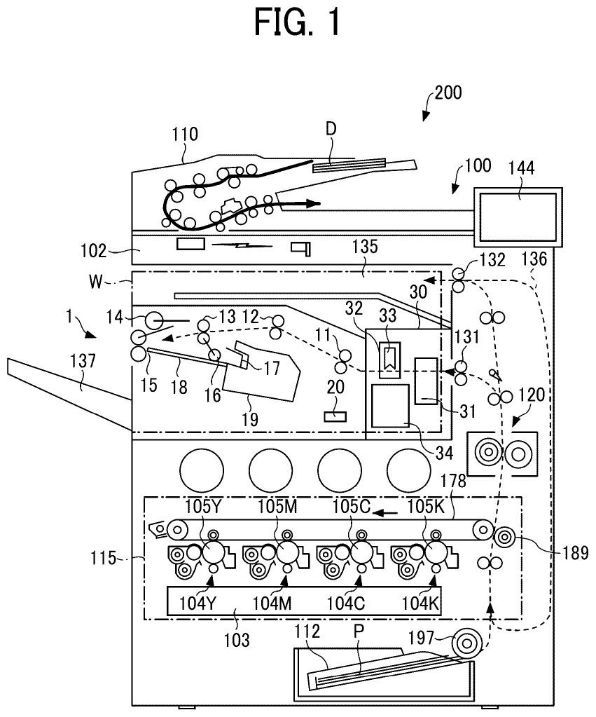

FIG. 1 is a schematic view illustrating a configuration of an image forming system 200 according to a first embodiment of the present disclosure.

The image forming system 200 includes an image forming apparatus 100 and a post-processing apparatus 1.

As will be described below, the image forming system 200 may include a plurality of image forming apparatuses 100 and a processing apparatus 300 that can communicate with each other via a network, but FIG. 1 illustrates a configuration of one image forming apparatus 100 and the post-processing apparatus 1. The image forming apparatus 100 transfers, onto a sheet P, a read image or print data received from, for example, a terminal device to form an image.

The post-processing apparatus 1 performs post-processing on the sheet P conveyed from the image forming apparatus 100. The sheet P is, for example, paper such as plain paper or recycled paper. However, the sheet P may be, for example, an overhead projector sheet, a film, a flexible thin plate in addition to, for example, coated paper, label paper, or a material other than paper.

The image forming apparatus 100 is the part of the image forming system 200 other than the post-processing apparatus 1. In other words, the image forming system 200 includes the image forming apparatus 100 and the post-processing apparatus 1. The image forming apparatus 100 includes an image forming device 115, an apparatus feeding tray 112, a fixing device 120, a document conveyor 110, and the document reading device 102. The exterior of the image forming apparatus 100 is provided with an operation display 144 for displaying various information and inputting various commands in the image forming system 200.

A user can select a print mode on the operation display 144 of the image forming apparatus 100 and, for example, a terminal device that is communicable with the image forming apparatus 100. The image forming apparatus 100 forms an image on the sheet P based on the selected print mode.

The post-processing apparatus 1 includes a first conveying roller pair 11, a second conveying roller pair 12, a third conveying roller pair 13, a tapping roller 14, an ejection roller pair 15, a return roller 16, a reference fence 17, an internal tray 18, a binding device 19, a controller 20, and an ejection tray 137. The post-processing apparatus 1 is disposed on the downstream side of the image forming apparatus 100 in a conveyance direction of the sheet P. The controller 20 controls the overall operation of the post-processing apparatus 1 and causes the post-processing apparatus 1 to execute each function.

The first conveying roller pair 11 is a roller pair on the most upstream side of the post-processing apparatus 1, and the second conveying roller pair 12 is a roller pair disposed on the downstream side of the first conveying roller pair 11. The third conveying roller pair 13 is a roller pair that shifts the sheet P in the width direction of the sheet P in the post-processing apparatus 1.

The tapping roller 14 is a rolling element that conveys the sheet P toward the reference fence 17, and the ejection roller pair 15 is a roller pair on the most downstream side of the post-processing apparatus 1. The return roller 16 is a rolling element that conveys the sheet P to bring the sheet P into contact with the reference fence 17. The reference fence 17 is an alignment unit to which ends of sheets P contact so that the ends are aligned in the conveyance direction when the sheets P are subjected to a binding process by the binding device 19. The internal tray 18 is a tray provided inside the post-processing apparatus 1 that ejects the sheets P subjected to the binding process.

The post-processing apparatus 1 has a function that performs post-processing on the sheet P on which an image has been formed by the image forming apparatus 100. The post-processing apparatus 1 has a binding process function of sequentially stacking sheets P on which images are formed, forming a sheet bundle including a plurality of sheets P, and performing the binding process at an end of the sheet bundle. In addition, the post-processing apparatus 1 may have various functions such as a hole-punching function of performing a punching process on a sheet bundle, a sorting function, a sheet alignment function, a sheet folding function, and a sheet cutting function.

In the illustrated example, the post-processing apparatus 1 is detachably provided in an in-body space W which is a space provided between the document reading device 102 and the image forming device 115 of the image forming apparatus 100. The in-body space Wis a space to which a sheet P ejected from the image forming apparatus 100 can be ejected, and is also a space from which the ejected sheet P can be taken out. That is, in a state where the post-processing apparatus 1 is not installed, the in-body space W functions as a space in which the sheet P ejected from the image forming apparatus 100 is stacked.

Hereinafter, an image forming process in the image forming system 200 will be described with reference to FIG. 1. In the image forming apparatus 100 with reference to FIG. 1, multiple pairs of sheet conveying rollers disposed in the document conveyor 110 feed an original document D from a document loading table and convey the original document D in a direction indicated by arrow in FIG. 1. By so doing, the original document D passes over the document reading device 102. At this time, the document reading device 102 optically reads image data of the original document D while the original document D is passing over the document reading device 102.

The image data optically scanned by the document reading device 102 is converted into electrical signals. The electrical signals are then transmitted to a writing device 103 of the image forming device 115. Then, the writing device 103 irradiates photoconductor drums 105Y, 105M, 105C, and 105K with laser beams for respective colors based on the electrical signal image information, to perform an exposing process.

Then, a charging process, the exposing process, and a developing process are performed on the photoconductor drums 105Y, 105M, 105C, and 105K of respective image formation units 104Y, 104M, 104C, and 104K. As a result, desired images are formed on the photoconductor drums 105Y, 105M, 105C, and 105K, respectively.

The images formed on the photoconductor drums 105Y, 105M, 105C, and 105K are transferred and superimposed onto an intermediate transfer belt 178 to form a color image. The color image formed on the intermediate transfer belt 178 is transferred onto the surface of the sheet P fed and conveyed by a feeding roller 197 from the apparatus feeding tray 112 at a position at which the intermediate transfer belt 178 faces a secondary transfer roller 189. The sheet P bearing the full-color image is conveyed to the fixing device 120. Then, the color image transferred on the surface is fixed on the sheet P.

Thereafter, based on a print mode selected by the user, the sheet P is ejected from the image forming apparatus 100 by an ejection roller pair 131 and is fed into the post-processing apparatus 1, or the sheet P is ejected from the image forming apparatus 100 by an ejection roller pair 132 and is stacked on an ejection tray 135.

In a case where the printing mode is a duplex printing mode, the sheet P is ejected from the image forming apparatus 100 to the ejection tray 135 by the ejection roller pair 132, and then, the sheet P is switched back to a reverse path 136 and is conveyed by the reverse rotation of the ejection roller pair 132. Then, the sheet P whose front and back are reversed is conveyed to a position where the secondary transfer roller 189 and the intermediate transfer belt 178 face each other, and an image is formed on the back surface.

Here, post-processing executed by the post-processing apparatus 1 for each function enabled by user's selection will be described. The post-processing apparatus 1 performs post-processing on the sheet P conveyed from the image forming apparatus 100.

When the sorting function is enabled, the sheets P are stacked on the ejection tray 137 in a sorted state in which the positions of the sheets P are shifted by a predetermined number of sheets P in the direction orthogonal to an ejection direction. At this time, the post-processing apparatus 1 controls a tray moving unit that moves the ejection tray 137 by a predetermined amount in a direction orthogonal to the direction in which the sheet P is ejected.

In a case where the binding process function is enabled, the sheets P conveyed by the first conveying roller pair 11, the second conveying roller pair 12, and the third conveying roller pair 13 are sequentially stacked on the internal tray 18 without being ejected to the ejection tray 137 by the ejection roller pair 15. Every time the sheet P is placed on the internal tray 18, the tapping roller 14 and the return roller 16 disposed above the internal tray 18 move from a standby position to a position where the tapping roller 14 and the return roller 16 contact the uppermost sheet P of the stacked sheet bundle.

Then, the sheet P moves toward the reference fence 17 by rotational driving of the tapping roller 14 and the return roller 16. Rear ends in the conveyance direction of sheets P included in the sheet bundle contact the reference fence 17, and positions of the plurality of sheets P are aligned in the conveyance direction.

At this time, side fences installed at both ends in the width direction of the internal tray 18 move in the width direction so as to sandwich the sheet bundle every time the sheet P is placed on the internal tray 18 or after a desired number of sheets P are stacked. Then, the positions of the sheets P are aligned in the width direction. Thereafter, the binding device 19 performs the binding process on the rear ends of the plurality of sheets P aligned in each of the conveyance direction and the width direction of the sheets P.

The sheet bundle subjected to the sheet binding process is then moved obliquely upward along the tray surface of the internal tray 18 by the reverse rotation of the return roller 16, and is ejected onto the ejection tray 137 by the ejection roller pair 15.

When the hole-punching function is enabled, a punching process is performed by a punching mechanism 30 included in the post-processing apparatus 1. The punching mechanism 30 includes a lateral registration detection device 31, a hole punching device 32, hole-punching pins 33, and a punch waste hopper 34.

The lateral registration detection device 31 moves in the width direction of the sheet P and detects an end face of the sheet P.

The hole punching device 32 moves in the width direction of the sheet P and aligns the hole-punching pins 33 in accordance with the detected end face of the sheet P. Each of the hole-punching pins 33 is a punching member that forms a hole or holes in the sheet P by penetrating the sheet P. Note that, for example, two or three hole-punching pins 33 may be provided, but the number is not limited thereto, and may be any number. The punch waste hopper 34 is, for example, a container that stores waste of the sheet P generated by the penetration of the hole-punching pins 33.

The lateral registration detection device 31 detects the position of the paper in the width direction by detecting the end face of the conveyed sheet P, and moves the hole punching device 32 in the width direction according to the position of the end face of the sheet P. The sheet P stops at a position where a punching process is performed, and the hole-punching pin 33 provided in the hole punching device 32 punches a punch hole in the stopped sheet P. Punch waste generated at the time of a punching process falls into the punch waste hopper 34 and is stored. After the punching process, the sheet P is conveyed to the first conveying roller pair 11.

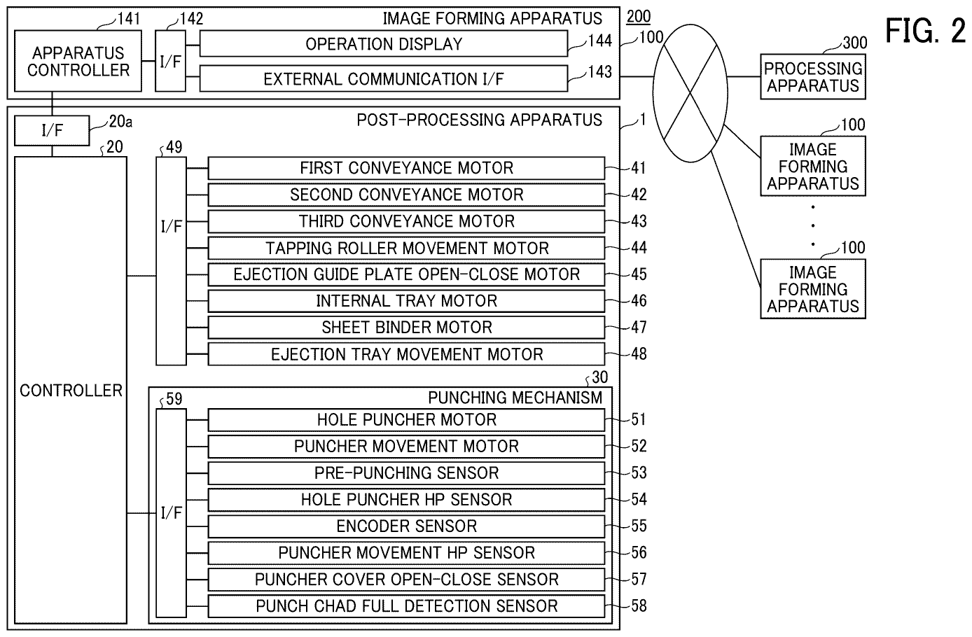

FIG. 2 is a block diagram illustrating a configuration of the image forming system 200 according to the first embodiment of the present disclosure.

In the image forming system 200, as illustrated in the drawing, the image forming apparatus 100 is communicable with the controller 20 of the post-processing apparatus 1 via an interface. Furthermore, the image forming apparatus 100 may be communicable with another image forming apparatus 100 and the processing apparatus 300 via a network. The processing apparatus 300 is, for example, a cloud server on a cloud, but is not limited thereto, and may be various information processing apparatuses.

The image forming apparatus 100 includes an apparatus controller 141, an interface 142, an external communication interface 143, and the operation display 144. The apparatus controller 141 is communicable with the external communication interface 143 and the operation display 144 via the interface 142. The image forming apparatus 100 is connected to the network via the external communication interface 143.

The controller 20 of the post-processing apparatus 1 is communicable with the image forming apparatus 100 via an interface 20a. The interface 20a is physically attachable and detachable by, for example, a relay connector, and a drawer connector.

The controller 20 is communicable with a first conveyance motor 41, a second conveyance motor 42, a third conveyance motor 43, a tapping roller movement motor 44, an ejection guide plate open-close motor 45, an internal tray motor 46, a sheet binder motor 47, and an ejection tray movement motor 48 via an interface 49.

The first conveyance motor 41, the second conveyance motor 42, the third conveyance motor 43, and the tapping roller movement motor 44 rotationally drive the first conveying roller pair 11, the second conveying roller pair 12, the third conveying roller pair 13, and the tapping roller 14, respectively. The ejection guide plate open-close motor 45 drives a guide for the sheet P to be ejected. The internal tray motor 46 drives the internal tray 18 that temporarily stores the sheets P in order to perform the binding process on the sheets P conveyed from the image forming apparatus 100. The sheet binder motor 47 is a motor that drives the binding device 19, and the ejection tray movement motor 48 is a motor that drives the ejection tray 137 that ejects the sheets P that have undergone the binding process.

The controller 20 is communicable with the punching mechanism 30 via an interface 59. The punching mechanism 30 includes a hole puncher motor 51 that drives a configuration for performing a punching process on the sheet P, a puncher movement motor 52, a pre-punch sensor 53 that detects a position of the sheet P on which the punching process is performed, and a hole puncher HP sensor 54 that detects a reference position of the hole punching. In addition, the punching mechanism 30 includes an encoder sensor 55 that detects a situation of a punching process, a punch movement HP sensor 56, a puncher cover open-close sensor 57, and a punch chad full detection sensor 58.

As will be described below, the post-processing apparatus 1 according to the present embodiment uses a trained model 9 for processing. The trained model 9 is stored in the controller 20 of the post-processing apparatus 1, but is not limited thereto, and may be stored in, for example, the apparatus controller 141 of the image forming apparatus 100, or the processing apparatus 300.

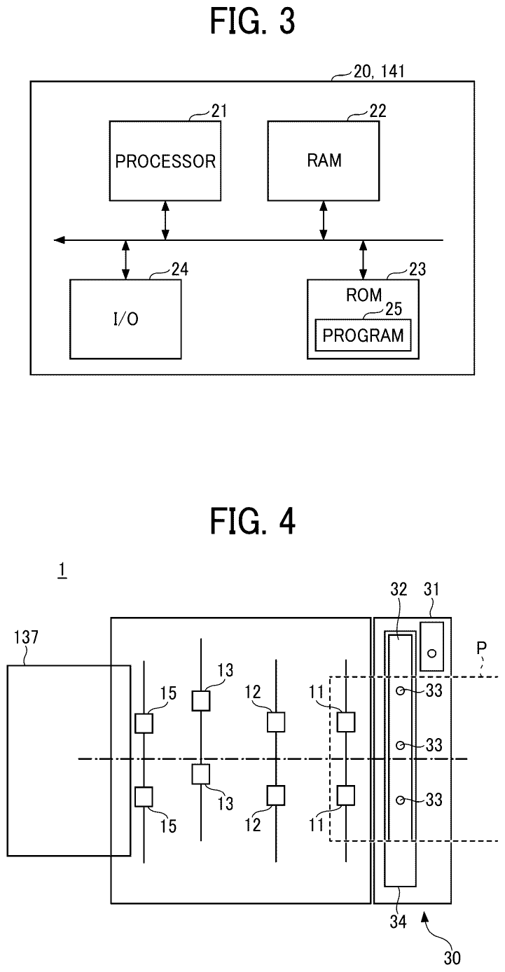

FIG. 3 is a diagram illustrating a hardware configuration of the controller 20 included in the post-processing apparatus 1 according to the first embodiment of the present disclosure and the apparatus controller 141 included in the image forming apparatus 100.

The controller 20 has a function as a computer. The controller 20 includes a processor 21, a random access memory (RAM) 22, a read only memory (ROM) 23, and an input/output (I/O) 24 connected to one another by a bus.

The processor 21 controls the entire post-processing apparatus 1 by executing a program 25 using the RAM 22 as a work memory. The processor 21 and the ROM 23 are non-volatile memories such as a flash memory, and store the program 25. The processor 21 includes various arithmetic devices such as a central processing unit (CPU) and a graphics processing unit (GPU). The processor 21 executes the program 25 to provide each function executed by the post-processing apparatus 1. The I/O 24 is an input/output interface.

### Configuration of Post-Processing Apparatus

FIG. 4 is a plan view of the post-processing apparatus 1 according to the first embodiment of the present disclosure.

The post-processing apparatus 1 includes the punching mechanism 30 that performs a punching process on the sheet P. When the hole-punching function is enabled by user's selection, the punching mechanism 30 performs the punching process on the sheet P on which the image is formed. When the hole-punching function is not enabled, the punching process is not performed on the sheet P passing through the punching mechanism 30.

The sheet P conveyed from the image forming apparatus 100 passes through the punching mechanism 30 and is delivered to the first conveying roller pair 11 of the post-processing apparatus 1. While the sheet P is conveyed from the image forming apparatus 100 to the post-processing apparatus 1, the lateral registration detection device 31 detects the position of the paper in the width direction by detecting the end face of the sheet P, and moves the hole punching device 32 in the width direction according to the position of the end face of the sheet P.

The sheet P stops at the position where the punching process is performed, and the hole-punching pin 33 provided in the hole punching device 32 punches a punch hole in the stopped sheet P. Punch waste generated at the time of the punching process falls into the punch waste hopper 34 and is stored. After the punching process, the sheet P is conveyed to the first conveying roller pair 11.

The post-processing apparatus 1 may receive the sheet P conveyed from the image forming apparatus 100 and the punching mechanism 30 by the first conveying roller pair 11, convey the sheet P to the ejection roller pair 15, and eject the sheet P to the ejection tray 137.

When the binding process function is enabled, the post-processing apparatus 1 receives the sheet P conveyed from the image forming apparatus 100 and the punching mechanism 30 by the first conveying roller pair 11, conveys the sheet P to the third conveying roller pair 13, and ejects the sheet P to the internal tray 18. Then, the post-processing apparatus 1 switchback conveys the sheet P by the tapping roller 14 and the return roller 16, and conveys the sheet P to the reference fence 17.

The post-processing apparatus 1 repeats this operation for a predetermined number of sheets, and when the final sheet P is conveyed to the reference fence 17, the binding device 19 drives a needle into the sheet bundle, and the ejection roller pair 15 ejects the sheet bundle to the ejection tray 137.

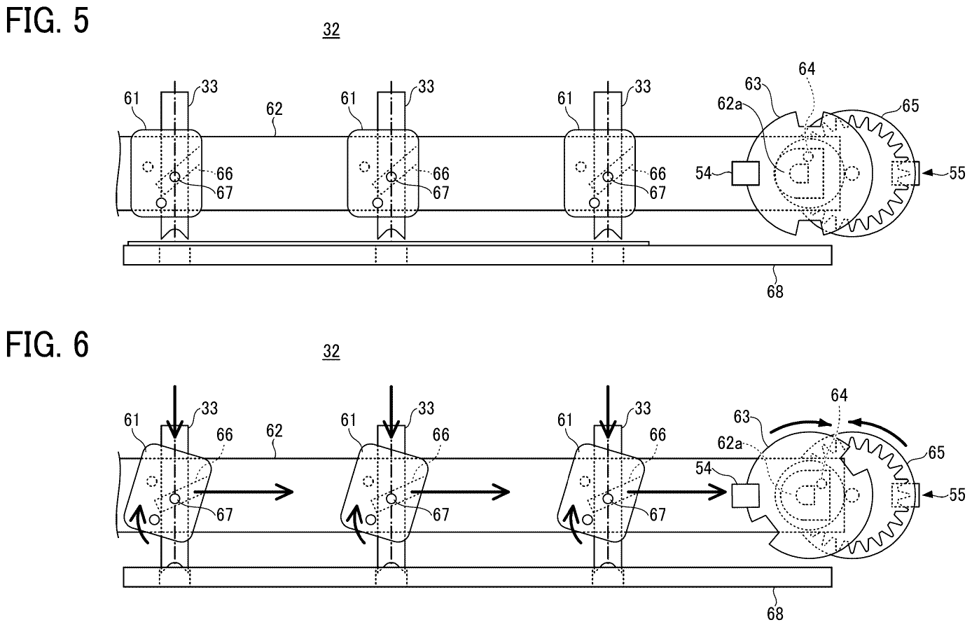

FIGS. 5 to 7 are views illustrating a configuration of the punching mechanism 30 in the post-processing apparatus 1 according to the first embodiment of the present disclosure.

FIG. 5 is a front view when a punching operation is not performed on the sheet P.

FIG. 6 is a front view during the punching operation.

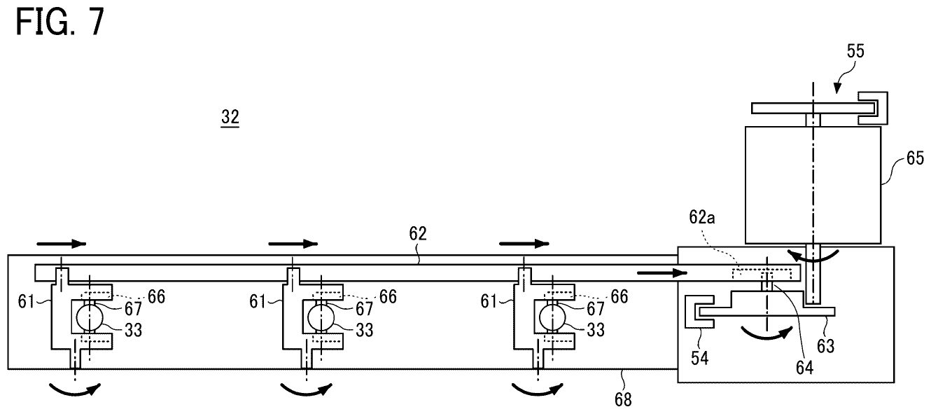

FIG. 7 is a plan view of the punching mechanism 30.

The punching mechanism 30 includes the hole-punching pins 33, links 61, an arm 62, a filler 63, a pin 64, and a motor 65. The arm 62 includes a groove 62a. Each of the links 61 includes a groove 66. Each of the hole-punching pins 33 is coupled to the corresponding link 61 by a pin 67. A die frame 68 is provided below the punching mechanism 30 in a direction in which the sheet bundle is conveyed.

When the motor 65 serving as a drive source rotates, the rotation is transmitted to the coupled filler 63. The filler 63 has a notch in the outer peripheral portion of the gear, and the reference position of the gear is detected by the hole puncher HP sensor 54 provided adjacent to the filler 63. The encoder sensor 55 provided coaxially with the motor 65 detects the rotation speed of the motor 65. The encoder sensor 55 can measure the time taken for performing the punching process on the sheet P by detecting the number of pulses corresponding to the rotation speed of the motor 65.

The pin 64 is attached to the filler 63, and is inserted into a groove 62a provided in the adjacent arm 62. As the filler 63 rotates, the pin 64 rotates and moves in the groove 62a of the arm 62. When the pin 64 moves in the groove 62a, the rotational motion of the filler 63 is converted into the linear motion of the arm 62 in the extension direction.

The arm 62 is coupled to the hole-punching pins 33 via the respective links 61, and the linear motion of the arm 62 in the extension direction is converted into a linear motion in the direction of performing the punching process on the sheet P by way of the links 61 and is transmitted to the hole-punching pins 33. The die frame 68 has holes on the sheet P side, and the sheet P is punched to forming a hole or holes by being pressed by the tips of the hole-punching pins 33 into the respective holes.

In this manner, the rotation of the motor 65 is transmitted to the tip portions of the hole-punching pins 33 via, for example, the arm 62. However, in the process in which the rotation of the motor 65 is transmitted to the hole-punching pins 33, components such as the pin 64 attached to the filler 63 and the groove 62a of the arm 62, and the arm 62 and the hole-punching pins 33 slide during operation.

Therefore, as the number of times of performing the punching process on the sheet P increases, the movable portions of the components deteriorate. When the components deteriorate, the rotation of the motor 65 is not appropriately transmitted to the hole-punching pins 33, so that the load at the time of performing the punching process on the sheet P increases. Then, the time taken to complete the punching process on the sheet P increases, and the power consumption of the motor 65 increases.

In addition, the tip portions of the hole-punching pins 33 have a sharp cutting edge shape so as to easily enter the sheet P when performing the punching process on the sheet P. However, when the number of times of the punching process increases, the tip portions are scraped to cause deterioration in which the cutting edges are rounded. As the tip portions of the hole-punching pins 33 are progressively worn out, the tip portions of the hole-punching pins 33 are less likely to enter the sheet P. Therefore, the time until completion of the punching process increases, and the power consumption of the motor 65 increases due to an increase in the load of the punching process.

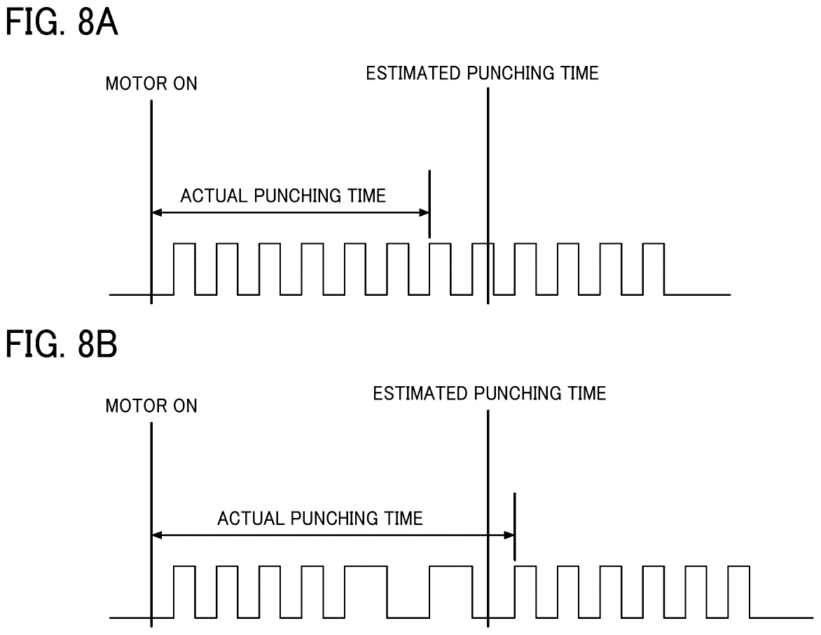

FIGS. 8A and 8B are diagrams illustrating examples of waveforms detected by the encoder sensor 55 of the post-processing apparatus 1 according to the first embodiment of the present disclosure.

FIG. 8A illustrates a waveform in an initial state of the punching mechanism 30.

FIG. 8B illustrates an example of a waveform in a case where the punching mechanism 30 is progressively worn out.

The illustrated waveforms are pulse waves detected by the encoder sensor 55 after the motor 65 is activated.

As illustrated, according to the waveform of the initial state of the punching mechanism 30 illustrated in FIG. 8A, the actual punching time is shorter than the estimated punching time, and according to the waveform when the punching mechanism 30 has been progressively worn out as illustrated in FIG. 8B, the actual punching time is longer than the estimated punching time. In addition, the waveform illustrated in FIG. 8B is wider than the waveform illustrated in FIG. 8A.

As described above, as the components included in the punching mechanism 30, such as the tip portions of the hole-punching pins 33 and the motor 65, are progressively worn out, the load at the time of the punching process increases as compared with the initial state, so that the time taken for the punching process increases and the width of the waveform also increases. In the embodiments of the present disclosure, as described below, a deterioration state of each component is determined by comparing an actual punching time and an estimated punching time obtained by estimating a reference punching time.

### Functional Configuration of Post-Processing Apparatus

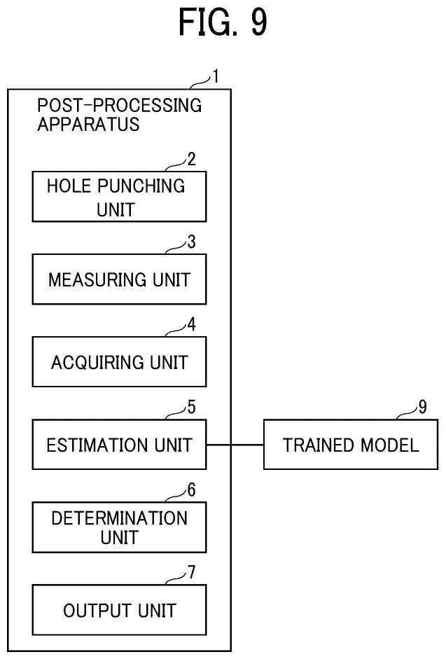

FIG. 9 is a block diagram illustrating a functional configuration of the post-processing apparatus 1 according to the first embodiment of the present disclosure.

The post-processing apparatus 1 includes a hole punching unit 2, a measuring unit 3, an acquiring unit 4, an estimation unit 5, a determination unit 6, and an output unit 7, and the estimation unit 5 uses a trained model 9. The functions of the hole punching unit 2 and the measuring unit 3 are implemented by the punching mechanism 30, and the functions of the acquiring unit 4, the estimation unit 5, the determination unit 6, and the output unit 7 are implemented by the controller 20.

The hole punching unit 2 includes the motor 65 that drives the punching unit, and performs the punching process on the sheet P by the punching unit. The punching unit is, for example, the hole-punching pins 33 included in the punching mechanism 30.

The measuring unit 3 obtains an actual punching time, which is the time taken for performing the punching process on the sheet P, based on the rotation speed of the motor 65. The rotation speed of the motor 65 is measured by, for example, an encoder sensor 55 included in the punching mechanism 30, and the actual punching time is output to the acquiring unit 4.

The acquiring unit 4 acquires sheet processing information including processing content performed on the sheet P until the sheet P is ejected and information regarding the sheet P, and the actual punching time. The acquiring unit 4 acquires the sheet processing information from the image forming apparatus 100, but is not limited thereto, and can acquire the sheet processing information from another apparatus. The acquiring unit 4 acquires the actual punching time from the measuring unit 3.

In addition, in a case where an image is included in print data, the acquiring unit 4 can acquire information regarding the position of the image in the print data from the image forming apparatus 100. At this time, when no image is included in the region of the print data corresponding to the punching position, the estimation unit 5 can set the image area ratio in the sheet processing information to 0 in the trained model 9 from the viewpoint of shortening the punching time. That is, even when the print data includes an image, if the image is not included in the region of the print data corresponding to the punching position, the print data is regarded as blank from the viewpoint of the load at the time of the punching process.

The estimation unit 5 inputs the sheet processing information to the trained model 9 obtained by machine-learning using the sheet processing information and the actual punching time as training data, to cause the trained model 9 to obtain an estimated punching time. The trained model 9 may have a structure in which learning is performed by back propagation using, for example, a neural network, but is not limited thereto, and various structures can be adopted.

The determination unit 6 determines the wearing out of the components included in the hole punching unit 2 based on the actual punching time and the estimated punching time. More specifically, the determination unit 6 determines, for example, the progress of wearing out of the components, the presence or absence of failure, or the preferable timing of replacement, of the components included in the hole punching unit 2 based on a threshold value related to the time difference between the actual punching time and the estimated punching time.

Furthermore, in the post-processing apparatus 1, a preset determination value may be set. The preset determination value is a value for giving a notification related to replacement of the components included in the hole punching unit 2 and indicates a time difference smaller than a threshold value related to a time difference between the actual punching time and the estimated punching time. In this case, the determination unit 6 determines a replacement of the components included in the hole punching unit 2 based on the time difference between the actual punching time and the estimated punching time, and the preset determination value.

As the components included in the hole punching unit 2 are progressively worn out, the time taken for performing the punching process on the sheet P becomes longer. Therefore, when the time difference between the actual punching time and the estimated punching time is equal to or greater than the threshold value, the determination unit 6 determines that the components included in the hole punching unit 2 have been progressively worn out, or determines that the components have reached the end of life and the unit of the components included in the hole punching unit 2 needs to be replaced.

The output unit 7 outputs a result of the determination by the determination unit 6. The result of the determination output by the output unit 7 includes information on the replacement time of the components included in the hole punching unit 2 and information on deterioration of the components.

### Generation of Trained Model

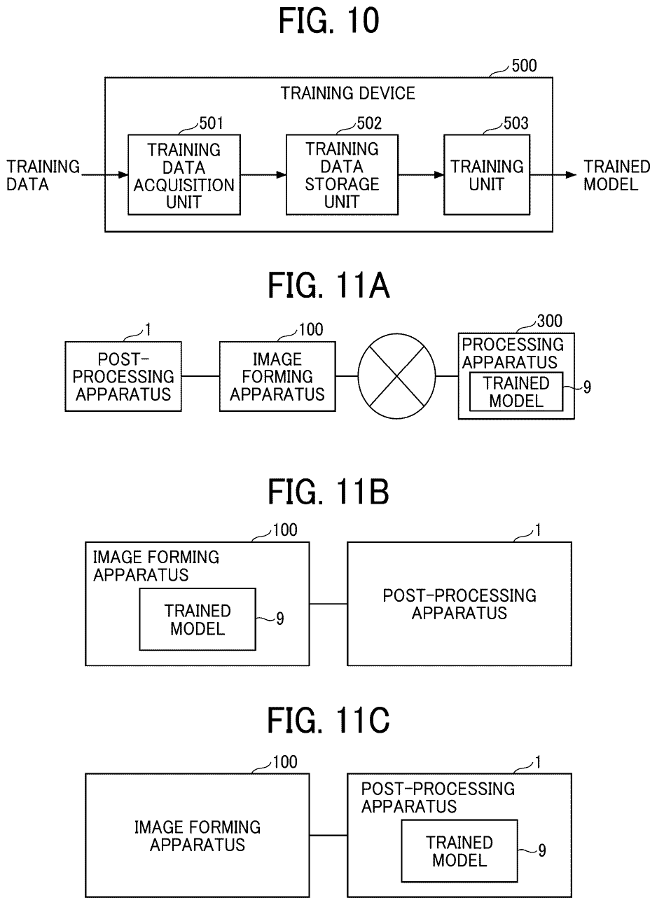

FIG. 10 is a block diagram illustrating a functional configuration of a training device 500 that generates the trained model 9 according to the first embodiment of the present disclosure.

The training device 500 can include a training data acquisition unit 501, a training data storage unit 502, and a training unit 503. Furthermore, the training device 500 can function as the training data acquisition unit 501 and the training unit 503 by executing a program. In addition, the training device 500 may be implemented in, for example, the processing apparatus 300 that is communicable with the image forming apparatus 100, or may be a single processing apparatus.

The training data acquisition unit 501 acquires training data. The training data acquisition unit 501 stores the acquired training data in the training data storage unit 502. The training data desirably includes numerical data such as the paper type and paper thickness of a sheet P. More specifically, the paper type includes the rigidity, smoothness, moisture content, internal bond strength, and fiber orientation angle of the sheet P. The paper thickness is, for example, a value of basis weight. The training data storage unit 502 stores training data.

The training unit 503 performs machine learning with each item of the training data included in the sheet processing information as an explanatory variable and the punching time of the sheet P as a response variable. As a result of learning using the trained data, the trained model 9 is generated.

As the trained model 9 according to the present embodiment, for example, a convolutional neural network (CNN) obtained by supervised learning using a trained data set is used. At the time of learning of the CNN, it is preferable to update the parameters of the CNN by back propagation (error back propagation method) so as to reduce the error between an output result by a detection model and a label.

FIGS. 11A to 11C are diagrams for explaining a relationship among the image forming apparatus 100, the post-processing apparatus 1, and the trained model 9 according to the first embodiment of the present disclosure.

As illustrated in FIG. 11A, the trained model 9 may be physically separated from the image forming apparatus 100 and the post-processing apparatus 1 and may be stored in the processing apparatus 300 connected via a network.

In this case, the trained model 9 generated by the training device 500 may be shared and used by a plurality of image forming apparatuses 100 included in the image forming system 200. More specifically, a determination result by the post-processing apparatus 1 of each image forming apparatus 100 illustrated in FIG. 2 is reflected in the training data, and the trained model 9 subjected to learning using the reflected training data is used for each image forming apparatus 100. Therefore, the estimation unit 5 can cause the trained model 9 to obtain the estimated punching time based on the sheet processing information and the actual punching time used in another image forming apparatus 100.

As illustrated in FIG. 11B, the trained model 9 may be stored in the image forming apparatus 100. Furthermore, as illustrated in FIG. 11C, the trained model 9 may be stored in the post-processing apparatus 1. Also in these cases, the trained model 9 may be shared and used by a plurality of image forming apparatuses 100 included in the image forming system 200.

### Database of Combined Sheet Processing Information and Actual Punching Time

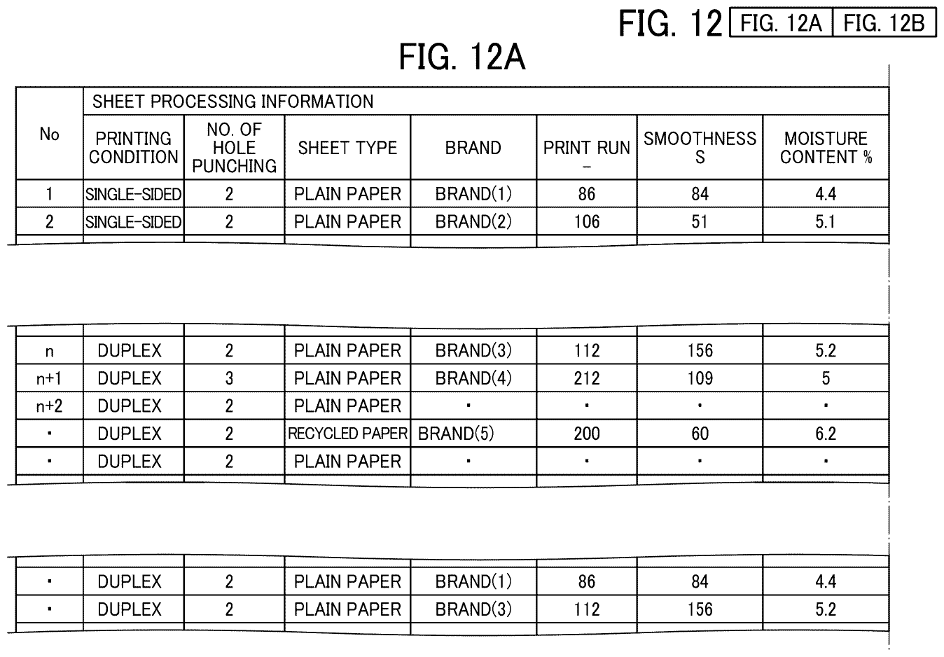

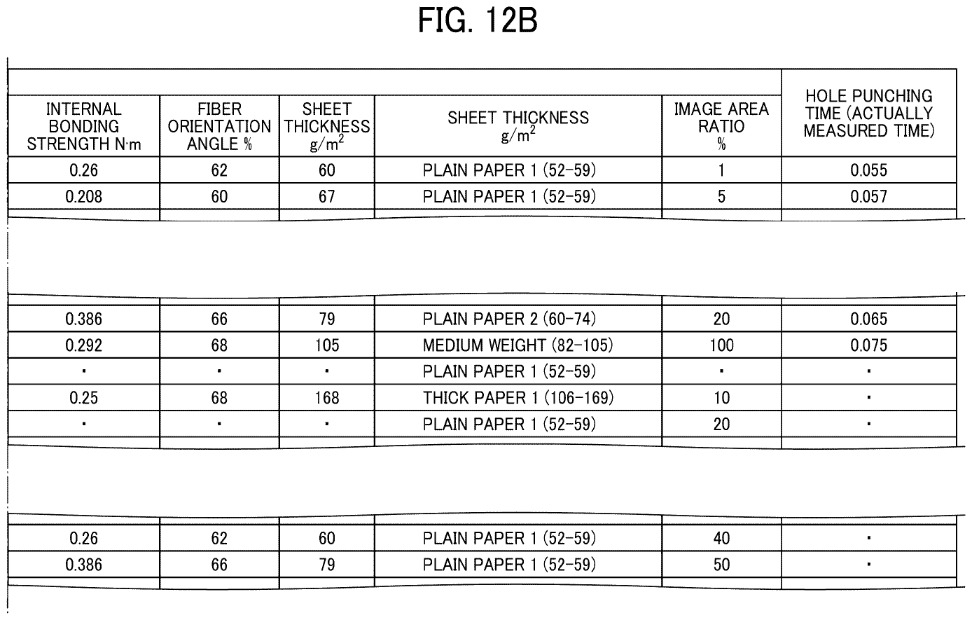

FIG. 12 including FIGS. 12A and 12B is a diagram illustrating an example of a database obtained by combining the sheet processing information and actual punching times according to the first embodiment of the present disclosure.

The sheet processing information includes information on the type and thickness of the sheet P. The sheet processing information further includes at least one of information regarding the number of hole punching, printing condition, or image area ratio of the sheet P. The trained model 9 is obtained by machine-learning using the database illustrated in FIGS. 12A and 12B of FIG. 12 as training data.

The information regarding the type and thickness, the number of hole punching, the printing condition, and the image area ratio of the sheet P included in the sheet processing information is selected from the viewpoint of whether the load at the time of the punching process is affected. For example, the load at the time of the punching process varies depending on the type, thickness, and number of hole punching in the sheet P. Furthermore, regarding the printing condition, since the thickness of the sheet P changes depending on whether the printing is double-sided printing or single-sided printing, the load at the time of the punching process differs. Furthermore, regarding the image area ratio, the amount of toner applied to the sheet P varies depending on whether the print data is text data or an image such as a photograph, and the thickness of the sheet P changes, so that the load at the time of the punching process differs.

In the sheet processing information in FIGS. 12A and 12B of FIG. 12, the “printing condition” is, for example, a printing mode such as a single-sided printing mode or a double-sided printing mode. The “number of hole punching” is the number of holes made by punching in the sheet P, and may be, for example, two or three, but is not limited thereto. The “paper type” is the type of the sheet P, and is, for example, plain paper, or recycled paper. The “brand” is a brand of the sheet P.

“Rigidity”, “smoothness”, “moisture content”, “internal bond strength”, “fiber orientation angle”, and “paper thickness” are information regarding the type and thickness of the sheet P, and indicate specification information of the sheet P. Note that the sheet processing information is not limited to the illustrated example, and may include various items.

In a case where the punching time is estimated without using the trained model 9, when the sheet processing information acquired from the image forming apparatus 100 has a parameter between “No. 1” and “No. 2” in FIG. 12 including FIGS. 12A and 12B, the estimation unit 5 estimates the punching time according to which of “No. 1” and “No. 2” the parameter is closer. That is, in the illustrated example, since one of 0.055 seconds and 0.057 seconds can be adopted as the punching time estimated by the estimation unit 5, the estimated punching time is discrete.

On the other hand, when the punching time is estimated using the trained model 9 as in the post-processing apparatus 1 of the present embodiment, the estimation unit 5 can estimate a value between 0.055 seconds and 0.057 seconds as the estimated punching time. That is, since a continuous value can be estimated as the estimated punching time, a more accurate punching time may be estimated.

Note that, depending on the image forming apparatus 100, it may fail to acquire information regarding, for example, the rigidity, smoothness, moisture content, internal bond strength, and fiber orientation angle of the sheet P among the sheet processing information. In this case, a fixed value corresponding to the classification related to the type and thickness of the sheet P may be set in advance, and the fixed value may be input to the trained model 9.

### Process Flow

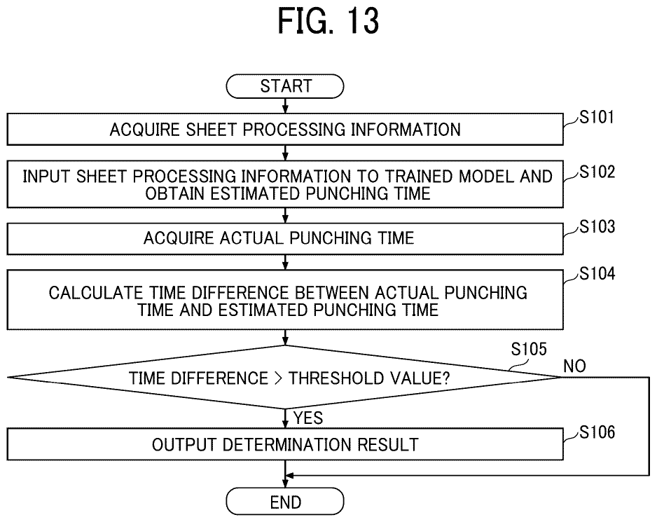

FIG. 13 is a flowchart of the flow of the process executed by the controller 20 of the post-processing apparatus 1 according to the first embodiment of the present disclosure.

First, the acquiring unit 4 of the post-processing apparatus 1 acquires sheet processing information from, for example, the image forming apparatus 100 (step S101). The estimation unit 5 inputs the sheet processing information to the trained model 9 and obtains the estimated punching time of the sheet P (step S102).

The acquiring unit 4 acquires the actual punching time measured by the measuring unit 3 (step S103). The determination unit 6 calculates a time difference between the actual punching time and the estimated punching time (step S104), and compares the calculated time difference with a threshold value (step S105).

When the calculated time difference is equal to or less than the threshold value (NO in step S105), the determination unit 6 determines that the components included in the hole punching unit 2 have not been progressively worn out and completes the processing. When the calculated time difference exceeds the threshold value (YES in step S105), the determination unit 6 determines that the components included in the hole punching unit 2 are deteriorated, and the output unit 7 outputs the result of the determination by the determination unit 6 and completes the processing (step S106).

Through these steps, the processing by the post-processing apparatus 1 according to the first embodiment of the present disclosure is executed. However, the processing by the post-processing apparatus 1 according to the first embodiment of the present disclosure may appropriately include other steps according to, for example, measurement conditions, and measurement environments.

### Modification 1

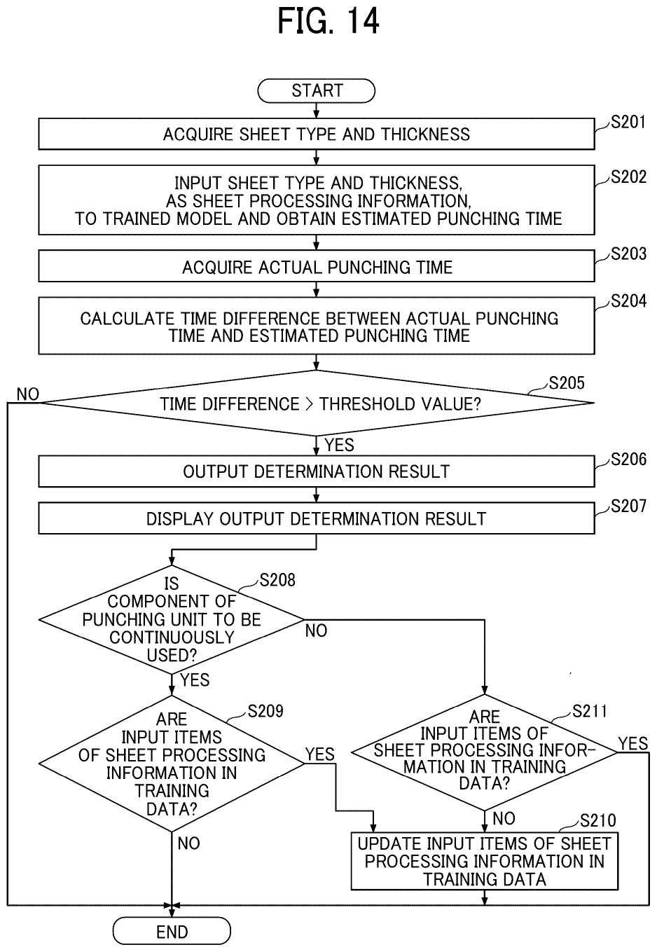

FIG. 14 is a flowchart of the flow of the process executed by the controller 20 of the post-processing apparatus 1 according to a modification of the first embodiment of the present disclosure.

First, the acquiring unit 4 of the post-processing apparatus 1 acquires information regarding the type and thickness of the sheet P among the sheet processing information from, for example, the image forming apparatus 100 (step S201). The estimation unit 5 inputs information regarding the type and thickness of the sheet P to the trained model 9 to estimate the estimated punching time of the sheet P (step S202).

The acquiring unit 4 acquires the actual punching time measured by the measuring unit 3 (step S203). The determination unit 6 calculates a time difference between the actual punching time and the estimated punching time (step S204), and compares the calculated time difference with a threshold value (step S205).

When the calculated time difference is equal to or less than the threshold value (NO in step S205), the determination unit 6 determines that the components included in the hole punching unit 2 have not been progressively worn out and completes the processing. When the calculated time difference exceeds the threshold value (YES in step S205), the determination unit 6 determines that the components included in the hole punching unit 2 have been progressively worn out, and the output unit 7 outputs the result of the determination by the determination unit 6 (step S206).

The operation display 144 of the image forming apparatus 100 displays that the unit of the hole punching unit 2 is preferable to be replaced based on the output determination result (step S207). When the components included in the hole punching unit 2 determined to be deteriorating are continuously used (YES in step S208) and the type and thickness of the sheet P are not included in the training data (NO in step S209), the controller 20 completes the processing. When the type and thickness of the sheet P are included in the training data (Yes in step S209), the controller 20 updates the training data by adding the sheet processing information of the type and thickness of the sheet P to the training data, and completes the processing (step S210).

When the components included in the hole punching unit 2 determined to be deteriorating are not continuously used (No in step S208) and the type and thickness of the sheet P are included in the training data (Yes in step S211), the controller 20 completes the processing. When the type and thickness of the sheet P are not included in the training data (No in step S211), the controller 20 adds sheet processing information of the type and thickness of the sheet P to the training data and completes the processing (step S210).

According to the modification described above, the post-processing apparatus 1 can determine with higher accuracy how much the components included in the punching mechanism 30, such as the hole-punching pins 33 and the motor 65, which are the punching members included in the punching mechanism 30, have been progressively worn out.

### Modification 2

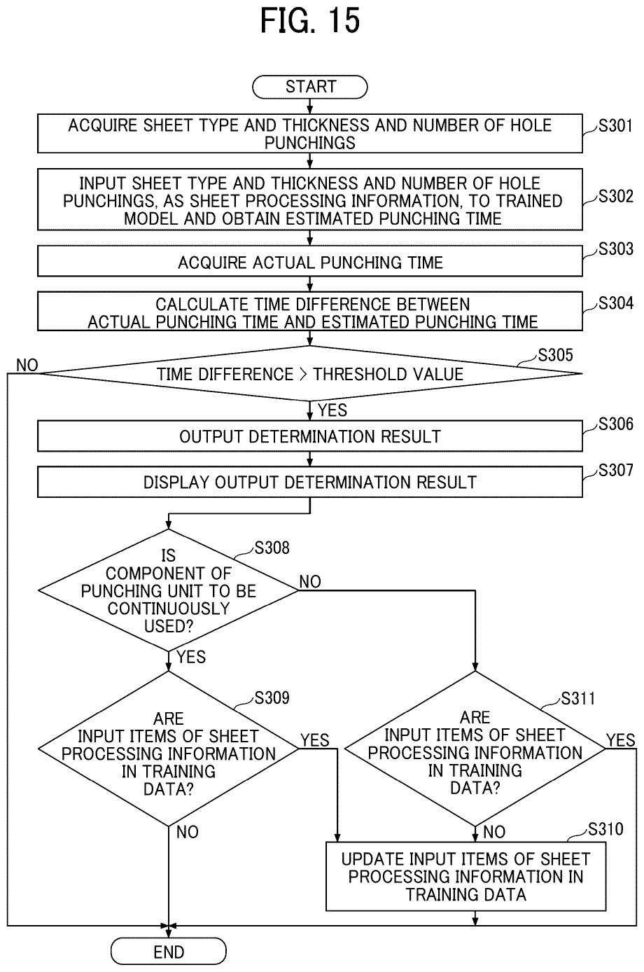

FIG. 15 is a flowchart of the flow of the process executed by the controller 20 of the post-processing apparatus 1 according to a modification of the first embodiment of the present disclosure.

In the present modification, unlike Modification 1, the estimation unit 5 estimates the estimated punching time using information regarding the type, thickness, and number of hole punching in the sheet P in the sheet processing information.

First, the acquiring unit 4 of the post-processing apparatus 1 acquires information regarding the type, thickness, and number of hole punching in the sheet P among the sheet processing information from, for example, the image forming apparatus 100 (step S301). The estimation unit 5 inputs information regarding the type, thickness, and number of hole punching in the sheet P to the trained model 9 to estimate the estimated punching time of the sheet P (step S302).

The following processing of steps S303 to S311 is similar to the processing of steps S203 to S211 described with reference to FIG. 14. According to the modification described above, the post-processing apparatus 1 can determine with higher accuracy how much the components included in the punching mechanism 30, such as the hole-punching pins 33 and the motor 65, which are the punching members included in the punching mechanism 30, have been progressively worn out.

### Modification 3

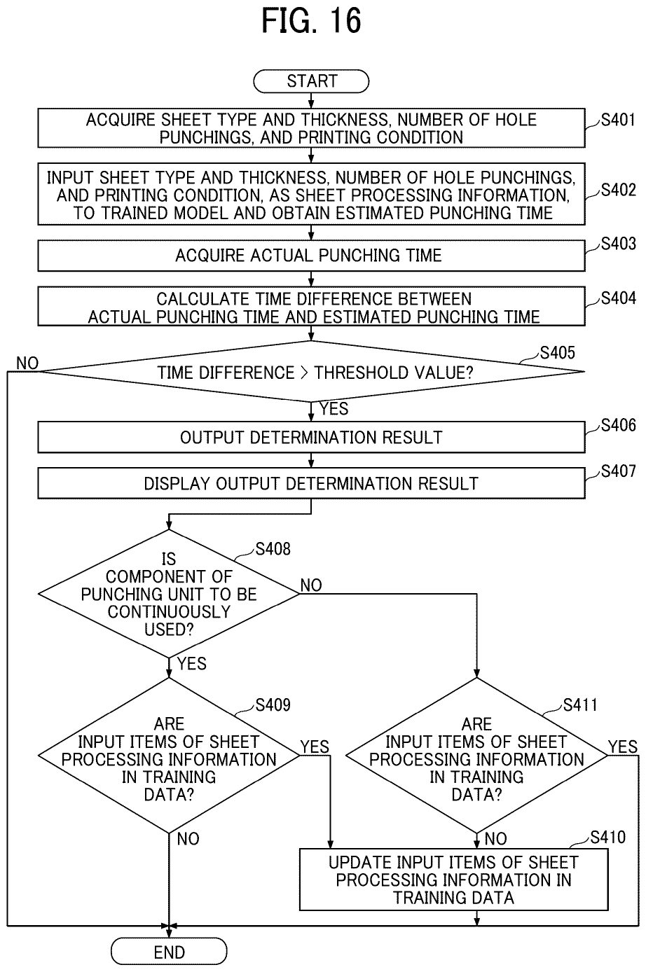

FIG. 16 is a flowchart of the flow of the process executed by the controller 20 of the post-processing apparatus 1 according to a modification of the first embodiment of the present disclosure.

In the present modification, unlike Modification 1, the estimation unit 5 estimates the estimated punching time using information regarding the type, thickness, the number of hole punching, and printing condition of the sheet P in the sheet processing information.

First, the acquiring unit 4 of the post-processing apparatus 1 acquires information regarding the type, thickness, number of hole punching, and printing condition of the sheet P among the sheet processing information from, for example, the image forming apparatus 100 (step S401). The estimation unit 5 inputs information regarding the type, thickness, number of hole punching, and printing condition of the sheet P to the trained model 9 to estimate the estimated punching time of the sheet P (step S402).

The following processing of steps S403 to S411 is similar to the processing of steps S203 to S211 described with reference to FIG. 14. According to the modification described above, the post-processing apparatus 1 can determine with higher accuracy how much the components included in the punching mechanism 30, such as the hole-punching pins 33 and the motor 65, which are the punching members included in the punching mechanism 30, have been progressively worn out.

### Modification 4

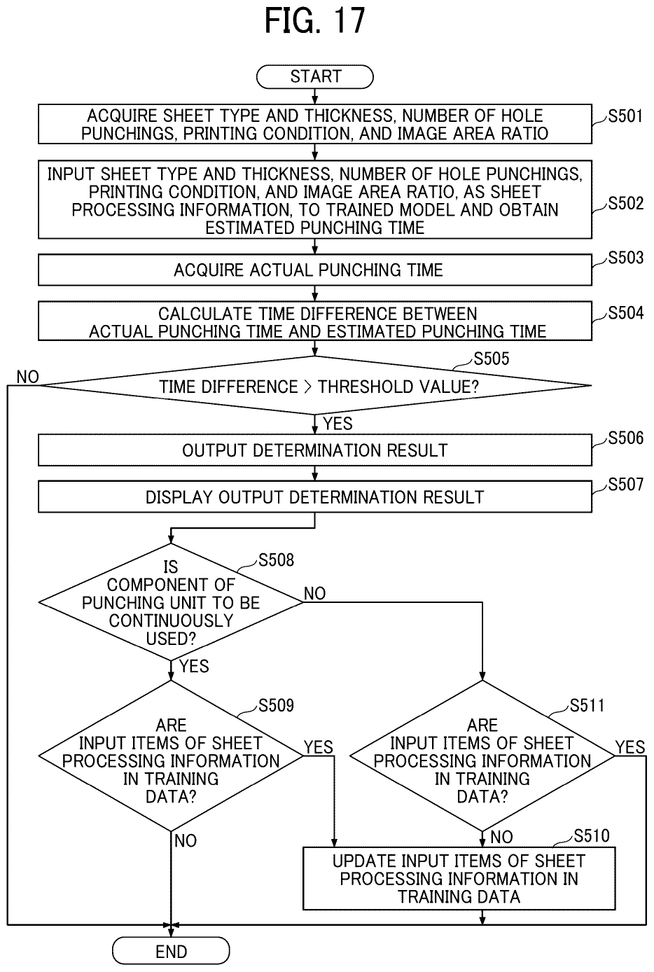

FIG. 17 is a flowchart of the flow of the process executed by the controller 20 of the post-processing apparatus 1 according to a modification of the first embodiment of the present disclosure.

In the present modification, unlike Modification 1, the estimation unit 5 estimates the estimated punching time using information regarding the type, thickness, number of hole punching, printing condition, and image area ratio of the sheet P in the sheet processing information.

First, the acquiring unit 4 of the post-processing apparatus 1 acquires information regarding the type, thickness, number of hole punching, printing condition, and image area ratio of the sheet P among the sheet processing information from, for example, the image forming apparatus 100 (step S501). The estimation unit 5 inputs information regarding the type, thickness, number of hole punching, printing condition, and image area ratio of the sheet P to the trained model 9 to estimate the estimated punching time of the sheet P (step S502).

The following processing of steps S503 to S511 is similar to the processing of steps S203 to S211 described with reference to FIG. 14. According to the modification described above, the post-processing apparatus 1 can determine with higher accuracy how much the components included in the punching mechanism 30, such as the hole-punching pins 33 and the motor 65, which are the punching members included in the punching mechanism 30, have been progressively worn out.

### Modification 5

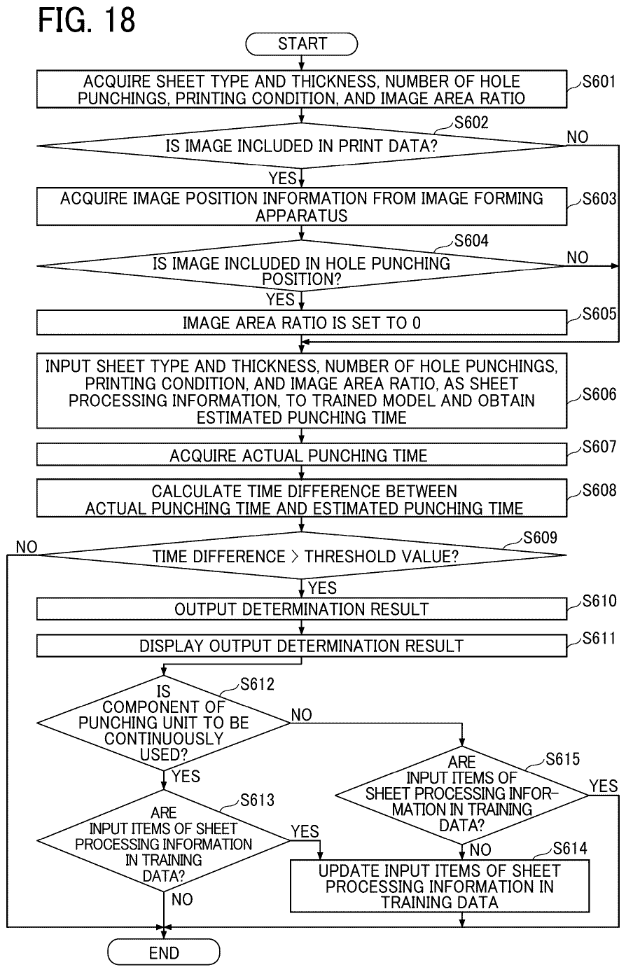

FIG. 18 is a flowchart of the flow of the process executed by the controller 20 of the post-processing apparatus 1 according to a modification of the first embodiment of the present disclosure.

In the present modification, unlike Modification 4, in a case where an image is included in print data, the acquiring unit 4 acquires information regarding the position of the image in the print data from the image forming apparatus 100. When no image is included in the region of the print data corresponding to the punching position, the estimation unit 5 does not input the information regarding the image area ratio in the sheet processing information to the trained model 9, but inputs information other than the image area ratio.

First, the acquiring unit 4 of the post-processing apparatus 1 acquires information regarding the type, thickness, number of hole punching, printing condition, and image area ratio of the sheet P among the sheet processing information from, for example, the image forming apparatus 100 (step S601). When no image is included in the print data read by the image forming apparatus 100 (No in step S602), the controller 20 executes the processing in step S606.

When an image is included in the print data read by the image forming apparatus 100 (Yes in step S602), the acquiring unit 4 acquires information on the position of the image in the print data from the image forming apparatus 100 (step S603).

When no image is included in the region of the print data corresponding to the punching position (Yes in step S604), the estimation unit 5 sets the image area ratio of the sheet processing information input to the trained model 9 to 0 (step S605). When an image is included in the region of the print data corresponding to the punching position (No in step S604), the controller 20 executes the processing of step S606.

The estimation unit 5 inputs information regarding the type, thickness, number of hole punching, printing condition, and image area ratio of the sheet P to the trained model 9 to estimate the estimated punching time of the sheet P (step S606). The following processing of steps S607 to S615 is similar to the processing of steps S503 to S511 described with reference to FIG. 17, respectively.

In other words, the processing of step S605 is a process of regarding the print data as blank from the viewpoint of the load at the time of the punching process even when the print data includes an image. As in the present modification, in a case where an image is included in the print data, the input data can be reviewed by acquiring information regarding the position of the image in the print data from the image forming apparatus 100. Therefore, according to the present modification, the post-processing apparatus 1 can determine with higher accuracy how much the components included in the punching mechanism 30, such as the hole-punching pin 33 and the motor 65, which are the punching members included in the punching mechanism 30, have been progressively worn out.

### Modification 6

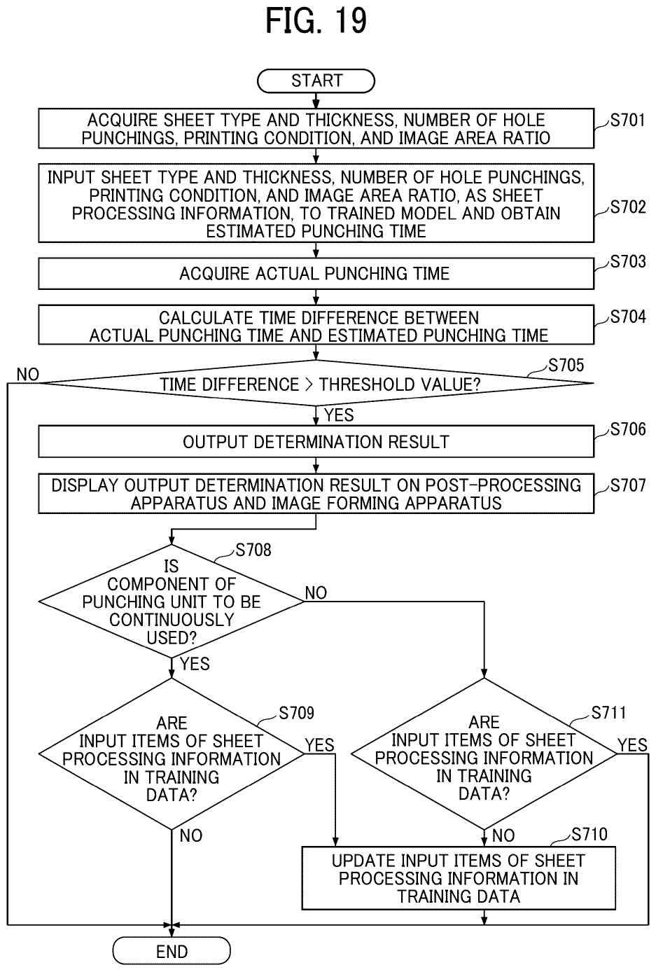

FIG. 19 is a flowchart of the flow of the process executed by the controller 20 of the post-processing apparatus 1 according to a modification of the first embodiment of the present disclosure.

In the present modification, unlike Modification 4, a display unit is provided in the post-processing apparatus 1, and a determination result is displayed. Therefore, the determination result output by the output unit 7 is displayed on both the operation display 144 of the image forming apparatus 100 and the display unit included in the post-processing apparatus 1.

The processing of steps S701 to S706 is similar to the processing of steps S501 to S506 described with reference to FIG. 17, respectively. When the output unit 7 outputs the determination result (step S706), the determination result output by the output unit 7 is displayed on both the operation display 144 of the image forming apparatus 100 and the display unit included in the post-processing apparatus 1 (step S707). Then, the controller 20 executes the processing of steps S708 to S711 similarly to the processing of steps S508 to S511 described with reference to FIG. 17, respectively.

According to the present modification, the user can confirm deterioration of the components included in the punching mechanism 30 by both the image forming apparatus 100 and the post-processing apparatus 1.

### Modification 7

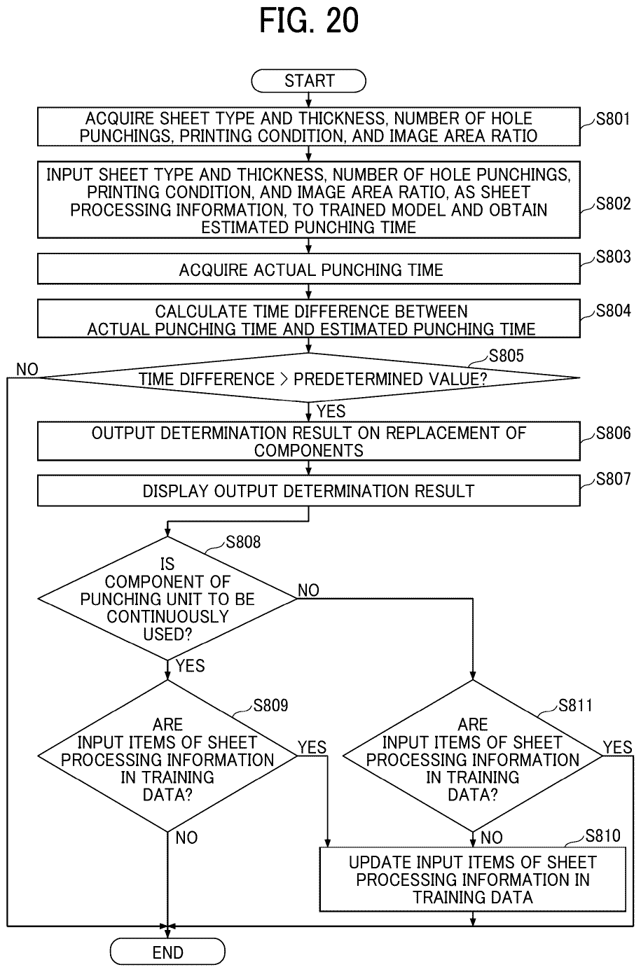

FIG. 20 is a flowchart of the flow of the process executed by the controller 20 of the post-processing apparatus 1 according to a modification of the first embodiment of the present disclosure.

In the present modification, unlike Modification 6, a preset determination value is set. The preset determination value is a value for giving a notification related to replacement of the components included in the hole punching unit 2, and indicates a time difference smaller than a threshold value related to a time difference between the actual punching time and the estimated punching time. Then, the determination unit 6 determines a replacement of the components included in the hole punching unit 2 based on the time difference between the actual punching time and the estimated punching time, and the preset determination value. That is, in the present modification, the post-processing apparatus 1 notifies the user of the preferable timing of replacement of the components included in the hole punching unit 2 before reaching the stage of determining the failure of the components.

The processing of steps S801 to S804 is similar to the processing of steps S701 to S704 described with reference to FIG. 19, respectively. The determination unit 6 compares the time difference between the actual punching time and the estimated punching time with the preset determination value (step S805). When the time difference calculated by the determination unit 6 is equal to or less than the preset determination value (No in step S805), the determination unit 6 determines that notification of information on replacement of the components included in the hole punching unit 2 is not preferable and completes the processing.

When the time difference calculated by the determination unit 6 exceeds the preset determination value (Yes in step S805), the determination unit 6 determines that notification of information on replacement of the components included in the hole punching unit 2 is preferable. The output unit 7 outputs a result of determination made by the determination unit 6 on replacement of the components included in the hole punching unit 2 (step S806). Then, the controller 20 executes the processing of steps S807 to S811 similarly to the processing of steps S707 to S711 described with reference to FIG. 17, respectively.

According to the present modification, since the post-processing apparatus 1 can alert a user to replacement of the components included in the hole punching unit 2 before the components fail, it is possible to suppress downtime after failure of the components.

### Operation and Effect of Post-Processing Apparatus According to First Embodiment

The post-processing apparatus 1 according to the present embodiment obtains a actual punching time, which is a time taken for performing the punching process on the sheet P, and inputs sheet processing information to the trained model 9 obtained by machine-learning using the sheet processing information and the actual punching time as training data, thereby causing the trained model 9 to obtain an estimated punching time. Then, the post-processing apparatus 1 determines deterioration of the components included in the hole punching unit 2 based on a threshold value related to a time difference between the actual punching time and the estimated punching time.

Since the post-processing apparatus 1 uses the trained model 9, the punching time can be estimated accurately even if sheet processing information such as the type and thickness of the sheet P for which the punching time has not been measured in advance is input. Therefore, according to the post-processing apparatus 1 according to the present embodiment, the deterioration state of the components included in the punching mechanism 30 can be estimated accurately.

### Second Embodiment

### Functional Configuration of Post-Processing Apparatus

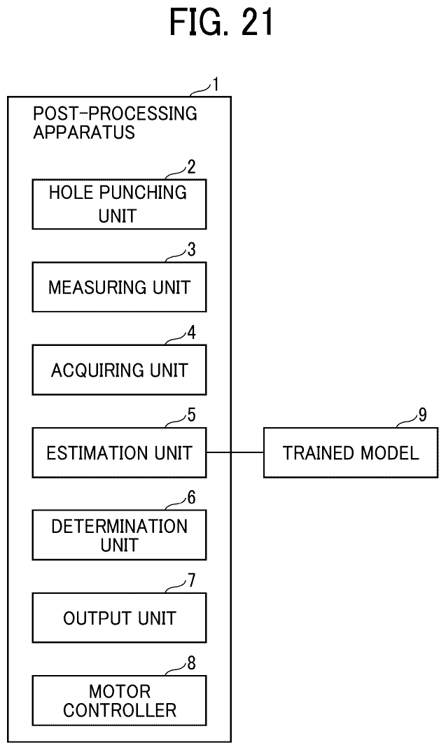

FIG. 21 is a block diagram illustrating a functional configuration of the post-processing apparatus 1 according to a second embodiment of the present disclosure.

The post-processing apparatus 1 includes the hole punching unit 2, the measuring unit 3, the acquiring unit 4, the estimation unit 5, the determination unit 6, the output unit 7, and a motor controller 8, and the estimation unit 5 uses the trained model 9. Unlike the first embodiment, the post-processing apparatus 1 according to the present embodiment includes the motor controller 8.

The functions of the hole punching unit 2 and the measuring unit 3 are implemented by the punching mechanism 30, and the functions of the acquiring unit 4, the estimation unit 5, the determination unit 6, the output unit 7, and the motor controller 8 are implemented by the controller 20. The same components as the components already described are denoted by the same reference numerals, and redundant description will be omitted.

The motor controller 8 extracts a past print job corresponding to a condition in the sheet processing information of the received print job, and controls the rotation speed of the motor 65 based on the time difference between the actual punching time and the estimated punching time in the past print job stored in advance. A storage unit that stores the past print job is provided in the post-processing apparatus 1, but is not limited thereto, and may be provided in another apparatus such as the image forming apparatus 100 and the processing apparatus 300 as illustrated in FIGS. 11A to 11C. The storage unit is implemented by a memory such as a RAM and a ROM.

### Process Flow

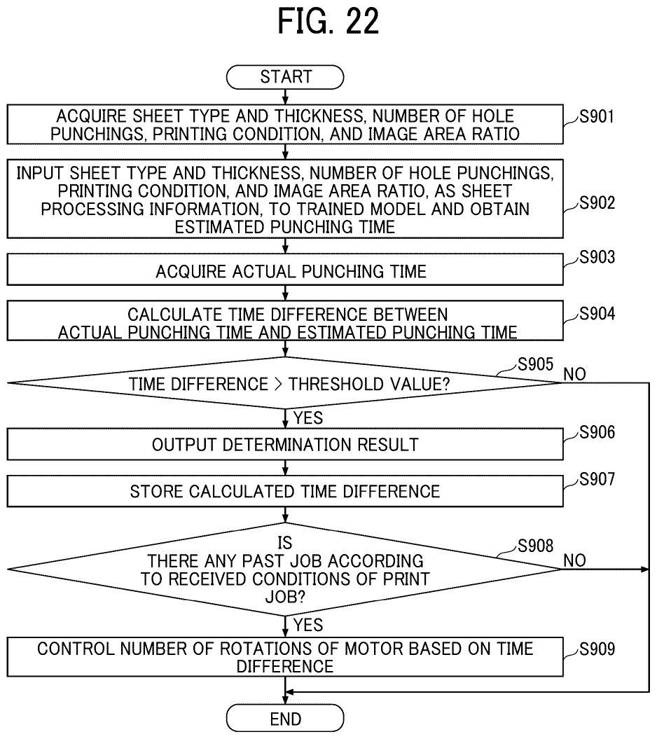

FIG. 22 is a flowchart of the flow of the process executed by the controller 20 of the post-processing apparatus 1 according to the second embodiment of the present disclosure.

First, the acquiring unit 4 of the post-processing apparatus 1 acquires information regarding the type, thickness, number of hole punching, printing condition, and image area ratio of the sheet P among the sheet processing information from, for example, the image forming apparatus 100 (step S901). The estimation unit 5 inputs information regarding the type, thickness, number of hole punching, printing condition, and image area ratio of the sheet P to the trained model 9 to estimate the estimated punching time of the sheet P (step S902).

The acquiring unit 4 acquires the actual punching time measured by the measuring unit 3 (step S903). The determination unit 6 calculates a time difference between the actual punching time and the estimated punching time (step S904), and compares the calculated time difference with a threshold value (step S905).

When the calculated time difference is equal to or less than the threshold value (NO in step S905), the determination unit 6 determines that the components included in the hole punching unit 2 have not been progressively worn out and completes the processing. When the calculated time difference exceeds the threshold value (YES in step S905), the determination unit 6 determines that the components included in the hole punching unit 2 have been progressively worn out, and the output unit 7 outputs the result of the determination by the determination unit 6 (step S906).

The storage unit of the post-processing apparatus 1 stores the calculated time difference (step S907). When there is no past print job corresponding to the condition of the received print job (No in step S908), the controller 20 of the post-processing apparatus 1 completes the processing.

When there is a past print job corresponding to the condition of the received print job (Yes in step S908), the motor controller 8 extracts the past print job corresponding to the condition in the sheet processing information of the received print job. The motor controller 8 controls the rotation speed of the motor 65 based on the time difference between the actual punching time and the estimated punching time in the past print job stored in advance (step S909).

### Operation and Effect of Post-Processing Apparatus According to Second Embodiment

The post-processing apparatus 1 according to the present embodiment extracts a past print job corresponding to the condition in the sheet processing information of the received print job, and controls the rotation speed of the motor 65 based on the time difference between the actual punching time and the estimated punching time in the past print job stored in advance. Therefore, the motor controller 8 can suppress the deterioration of the productivity of the work accompanying the execution of the print job by advancing or delaying the rotation speed of the motor 65 according to the time difference in the past print job.

Although the post-processing apparatus, the image forming apparatus, and the image forming system according to the embodiments have been described above, this disclosure is not limited to the above-described embodiments, and various modifications and improvements are possible within the scope of the present disclosure.

Each of the functions of the embodiments described above may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

A description is now given below of several aspects of the present disclosure.

### Aspect 1

In Aspect 1, a post-processing apparatus that performs post-processing on a conveyed sheet includes a hole punching unit, a measurement unit, an acquisition part, an estimation part, and a determination part. The hole punching unit includes a motor that drives a punching unit, the hole punching unit performing a punching process on the sheet by the punching unit. The measurement part obtains an actual punching time, which is a time taken for performing the punching process on the sheet, based on a rotation speed of the motor. The acquisition part acquires sheet processing information including processing content performed on the sheet until the sheet is ejected and information regarding the sheet, and the actual punching time. The estimation part causes a trained model to obtain an estimated punching time by inputting the sheet processing information to the trained model, and the trained model is obtained by machine-learning using the sheet processing information and the actual punching time as training data. The determination part determines deterioration of a component included in the hole punching unit based on a threshold value related to a time difference between the actual punching time and the estimated punching time.

### Aspect 2

In Aspect 2, in the post-processing apparatus according to Aspect 1, the acquisition part further acquires, as the sheet processing information, information regarding a type and a thickness of the sheet.

### Aspect 3

In Aspect 3, in the post-processing apparatus according to Aspect 2, the acquisition part further acquires, as the sheet processing information, at least one of information regarding the number of hole punching, a printing condition, or an image area ratio of the sheet.

### Aspect 4

In Aspect 4, in the post-processing apparatus according to Aspect 3, when print data includes an image, the acquisition part acquires information regarding a position of the image in the print data from an image forming apparatus, and when the image is not included in a region of the print data corresponding to a punching position, the estimation part inputs, to the trained model, the image area ratio in the sheet processing information as 0.

### Aspect 5

In Aspect 5, the post-processing apparatus according to any one of Aspects 1 to 4, further includes a motor controller that extracts a past print job corresponding to a condition in the sheet processing information of a received print job, and controls a rotation speed of the motor based on a time difference between the actual punching time and the estimated punching time in the past print job stored in advance.

### Aspect 6

In Aspect 6, in the post-processing apparatus according to any one of Aspects 1 to 5, a preset determination value is set, the preset determination value being a value for giving a notification related to replacement of a component included in the hole punching unit, the preset determination value indicating a time difference smaller than the threshold value related to the time difference between the actual punching time and the estimated punching time, and the determination unit determines a replacement of a component included in the hole punching unit based on the time difference between the actual punching time and the estimated punching time and the preset determination value.

### Aspect 7

In Aspect 7, the post-processing apparatus according to any one of Aspects 1 to 6, further includes an output part that outputs a result of determination by the determination part.

### Aspect 8

In Aspect 8, in the post-processing apparatus according to Aspect 7, the result of the determination output by the output part includes information on a replacement time of a component included in the hole punching unit and information on deterioration of the component.

### Aspect 9

In Aspect 9, an image forming apparatus includes the post-processing apparatus according to any one of Aspects 1 to 8.

### Aspect 10

In Aspect 10, an image forming system includes an image forming apparatus, a post-processing apparatus that performs post-processing on a sheet, and a processing apparatus connected to the image forming apparatus via a network. The post-processing apparatus includes a hole punching unit, a measurement part, an acquisition part, an estimation part, and a determination part. The hole punching unit includes a motor that drives a punching unit, the hole punching unit performing the punching process on the sheet by the punching unit. The measurement part obtains an actual punching time, which is a time taken for performing the punching process on the sheet, based on a rotation speed of the motor. The acquisition part acquires sheet processing information including processing content performed on the sheet until the sheet is ejected and information regarding the sheet, and the actual punching time. The estimation part causes a trained model to obtain an estimated punching time by inputting the sheet processing information to the trained model, and the trained model is obtained by machine-learning using the sheet processing information and the actual punching time as training data. The determination part determines deterioration of a component included in the hole punching unit based on a threshold value related to a time difference between the actual punching time and the estimated punching time.

### Aspect 11

In Aspect 11, a post-processing apparatus includes a hole puncher and circuitry. The hole puncher includes a punching member, a motor, and a sensor. The punching member includes a part member. The motor drives the punching member to perform a punching process as a post-processing on a sheet. The sensor measures a number of rotations of the motor to measure an actual punching time of the punching process on the sheet. The circuitry is to acquire the actual punching time, and sheet processing information including a process content of the post-processing performed on the sheet before an ejection of the sheet from the post-processing apparatus, and sheet information of the sheet; generate a trained model through machine learning using the sheet processing information and the actual punching time as training data; input the sheet processing information to the trained model to estimate an estimated punching time; calculate a time difference between the actual punching time and the estimated punching time; and compare the time difference and a threshold value to determine deterioration of the part member of the hole puncher.

### Aspect 12

In Aspect 12, in the post-processing apparatus according to Aspect 11, the circuitry is further to acquire information related to a type of the sheet and a thickness of the sheet, as the sheet processing information.

### Aspect 13

In Aspect 13, in the post-processing apparatus according to Aspect 12, the circuitry is further to acquire information related to at least any one of a number of holes to be formed on the sheet by the hole puncher, a printing condition of print data to be printed on the sheet, or an image area ratio of an image printed on the sheet, as the sheet processing information.

### Aspect 14

In Aspect 14, in the post-processing apparatus according to Aspect 13, the circuitry is further to acquire information related to a position of the image in the sheet from an image forming apparatus when the print data includes the image, determine whether the image is out of a hole area in which the hole puncher forms the holes in the sheet, and input a value of zero, as the image area ratio of the sheet processing information, to the trained model when it is determined that the image is out of the hole area.

### Aspect 15

In Aspect 15, the post-processing apparatus according to any one of Aspects 11 to 14, the circuitry is further to extract a past print job having the sheet processing information corresponding to the sheet processing information of a current print job, and control the number of rotations of the motor based on the time difference between the actual punching time and the estimated punching time in the past print job stored in advance.

### Aspect 16

In Aspect 16, in the post-processing apparatus according to any one of Aspects 11 to 15, the circuitry is further to set an advance determination value indicating another time difference smaller than the threshold value, compare the time difference and the advance determination value, and output a notification of a replacement of the part member when the time difference exceeds the advance determination value.

### Aspect 17

In Aspect 17, the post-processing apparatus of any one according to Aspects 11 to 16, the circuitry is further to output a determination result of the deterioration of the part member of the hole puncher.

### Aspect 18

In Aspect 18, in the post-processing apparatus according to Aspect 17, the determination result includes information of a timing of replacement of the part member of the hole puncher, and information of the deterioration of the part member.

### Aspect 19

In Aspect 19, an image forming apparatus includes a post-processing apparatus to perform a post-processing on a sheet. The post-processing apparatus performs a post-processing on a sheet, and includes a hole puncher and circuitry. The hole puncher includes a punching member, a motor, and a sensor. The punching member includes a part member. The motor drives the punching member to perform a punching process as a post-processing on a sheet. The sensor measures a number of rotations of the motor to measure an actual punching time of the punching process on the sheet. The circuitry is to acquire the actual punching time and sheet processing information including a process content of the post-processing performed on the sheet before an ejection of the sheet from the post-processing apparatus, and sheet information of the sheet; generate a trained model through machine learning using the sheet processing information and the actual punching time as training data; input the sheet processing information to the trained model to estimate an estimated punching time; calculate a time difference between the actual punching time and the estimated punching time; and compare the time difference and a threshold value to determine deterioration of the part member of the hole puncher.

### Aspect 20

In Aspect 20, an image forming system includes an image forming apparatus, a processing apparatus, and a post-processing apparatus. The image forming apparatus form an image on a sheet. The processing apparatus is coupled to the image forming apparatus via a network. The post-processing apparatus performs a post-processing on the sheet conveyed from the image forming apparatus. The post-processing apparatus includes a hole puncher and circuitry. The hole puncher includes a punching member, a motor, a sensor. The punching member includes a part member. The motor drives the punching member to perform a punching process as a post-processing on a sheet. The sensor measures a number of rotations of the motor to measure an actual punching time of the punching process on the sheet. The circuitry is to acquire the actual punching time, and sheet processing information including a process content of the post-processing performed on the sheet before an ejection of the sheet from the post-processing apparatus, and sheet information of the sheet; generate a trained model through machine learning using the sheet processing information and the actual punching time as training data; input the sheet processing information to the trained model to estimate an estimated punching time; calculate a time difference between the actual punching time and the estimated punching time; and compare the time difference and a threshold value to determine deterioration of the part member of the hole puncher.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A post-processing apparatus comprising:
a hole puncher including:
a punching member including a part member;
a motor to drive the punching member to perform a punching process as a post-processing on a sheet; and
a sensor to measure a number of rotations of the motor to measure an actual punching time of the punching process on the sheet; and
circuitry configured to:
acquire:
the actual punching time; and
sheet processing information including:
a process content of the post-processing performed on the sheet before an ejection of the sheet from the post-processing apparatus; and
sheet information of the sheet;
generate a trained model through machine learning using the sheet processing information and the actual punching time as training data;
input the sheet processing information to the trained model to estimate an estimated punching time;
calculate a time difference between the actual punching time and the estimated punching time; and
compare the time difference and a threshold value to determine deterioration of the part member of the hole puncher.

2. The post-processing apparatus according to claim 1,
wherein the circuitry is further configured to acquire information related to:
a type of the sheet; and
a thickness of the sheet,
as the sheet processing information.

3. The post-processing apparatus according to claim 2,
wherein the circuitry is further configured to acquire information related to at least any one of:
a number of holes to be formed on the sheet by the hole puncher;
a printing condition of print data to be printed on the sheet; or
an image area ratio of an image printed on the sheet,
as the sheet processing information.

4. The post-processing apparatus according to claim 3,
wherein the circuitry is further configured to:
acquire information related to a position of the image in the sheet from an image forming apparatus when the print data includes the image;
determine whether the image is out of a hole area in which the hole puncher forms the holes in the sheet; and
input a value of zero, as the image area ratio of the sheet processing information, to the trained model when it is determined that the image is out of the hole area.

5. The post-processing apparatus according to claim 1,
wherein the circuitry is further configured to:
extract a past print job having the sheet processing information corresponding to the sheet processing information of a current print job; and
control the number of rotations of the motor based on the time difference between the actual punching time and the estimated punching time in the past print job stored in advance.

6. The post-processing apparatus according to claim 1,
wherein the circuitry is further configured to:
set an advance determination value indicating another time difference smaller than the threshold value;
compare the time difference and the advance determination value; and
output a notification of a replacement of the part member when the time difference exceeds the advance determination value.

7. The post-processing apparatus according to claim 1,
wherein the circuitry is further configured to output a determination result of the deterioration of the part member of the hole puncher.

8. The post-processing apparatus according to claim 7,
wherein the determination result includes:
information of a timing of replacement of the part member of the hole puncher; and
information of the deterioration of the part member.

9. An image forming apparatus comprising a post-processing apparatus to perform a post-processing on a sheet,
the post-processing apparatus including:
a hole puncher including:
a punching member including a part member;
a motor to drive the punching member to perform a punching process as a post-processing on a sheet; and
a sensor to measure a number of rotations of the motor to measure an actual punching time of the punching process on the sheet; and
circuitry configured to:
acquire:
the actual punching time; and
sheet processing information including:
a process content of the post-processing performed on the sheet before an ejection of the sheet from the post-processing apparatus; and
sheet information of the sheet;
generate a trained model through machine learning using the sheet processing information and the actual punching time as training data;
input the sheet processing information to the trained model to estimate an estimated punching time;
calculate a time difference between the actual punching time and the estimated punching time; and
compare the time difference and a threshold value to determine deterioration of the part member of the hole puncher.

10. An image forming system comprising:
an image forming apparatus to form an image on a sheet;
a processing apparatus coupled to the image forming apparatus via a network; and
a post-processing apparatus to perform a post-processing on the sheet conveyed from the image forming apparatus,
the post-processing apparatus including:
a hole puncher including:
a punching member including a part member;
a motor to drive the punching member to perform a punching process as a post-processing on a sheet; and
a sensor to measure a number of rotations of the motor to measure an actual punching time of the punching process on the sheet; and
circuitry configured to:
acquire:
the actual punching time; and
sheet processing information including:
a process content of the post-processing performed on the sheet before an ejection of the sheet from the post-processing apparatus; and
sheet information of the sheet;
generate a trained model through machine learning using the sheet processing information and the actual punching time as training data;
input the sheet processing information to the trained model to estimate an estimated punching time;
calculate a time difference between the actual punching time and the estimated punching time; and
compare the time difference and a threshold value to determine deterioration of the part member of the hole puncher.
